(19) United States
(12) Patent Application Publication
(10) Pub. No.: US 2003/0070171 A1
(43) Pub. Date: Apr. 10, 2003

(54) Method for displaying an electronic program guide on a screen of a digital television

(75) Inventors: Won-Geun Jeon, Seoul (KR); Deok-Hee Jeong, Seoul (KR)

Correspondence Address: MERCHANT & GOULD PC, P.O. BOX 2903, MINNEAPOLIS, MN, 55402-0903, US

(73) Assignee: ALTICAST, CORP., Seoul (KR)

(21) Appl. No.: 10/265,034

(22) Filed: Oct. 4, 2002

(30) Foreign Application Priority Data
Oct. 6, 2001 (KR) 2001-61591

(51) Int. Cl. G06F 3/00; H04N 5/445; G06F 13/00

(52) U.S. Cl. 725/56; 725/45; 725/44; 725/53

(57) ABSTRACT

The present invention relates to a method for displaying an electronic program guide on a screen of a digital television. A hundred of channels are classified by category, and representative functions of the EPG are classified into few categories. When searching the classified channels and programs, a time axis and a channel axis are arrange on the screen by being displayed in a vertical direction of the screen. By storing the searched channel once time in a predetermined device, the stored information can be used when searching the searched channel again.

### BACKGROUND OF THE INVENTION

1. Field of the Invention

The present invention relates to a method for displaying an Electronic Program Guide (Hereinafter referred as an EPG) on a screen of a digital television

2. Prior Art

A digital television or a television (hereinafter referred as a digital television) equipped with a set-top box capable of receiving a digital broadcasting receives a bit-stream digital broadcasting signal by a packet through a receiving section, extracts a broadcasting signal of a channel selected by a viewer, decodes the extracted broadcasting signal in an moving picture expert group phase (hereinafter referring as an MPEG) as a standard for moving picture and audio signal compression, and displays the compressed signal on a display such as a monitor or a liquid crystal display LCD).

Meanwhile, the digital television receives the EPG by a predetermined time interval and stores the EPG in a memory in the digital television. The stored EPG is used for a user to tune a specific channel. Since the EPG is displayed on the screen of the digital television by using a graphic processing block for searching program information by a timeline or by a channel, the viewer can search a program his/her wanting to watch in a various way, i.e., by a day, by a timeline, and by a broadcasting center.

However, in the displaying method of the EPG menu as described above, a conventional method, as shown in FIG. 9, displays channels broadcasting programs on a vertical axis of the EPG menu and broadcasting time on a horizontal axis of the EPG menu, while programs to be broadcasted are listed on the vertical axis in time order. Therefore, since the viewer should search the program by clicking an up, down, left or right key equipped to a channel selection means of a remote controller when the viewer searches the program of the selected channel in time order after searching the channel, it should take a long time to search the program which the viewer wishes to watch. Moreover, for searching the searched channel again, the viewer should repeatedly search a hundred of channels again.

Moreover, according to the conventional EPG displaying method, channels increased in geometrical progression and the programs provided by the channels are difficult to be displayed, it is inconvenient to grasp the information for the starting time and ending time of the corresponding program.

### SUMMARY OF THE INVENTION

Therefore, the present invention is made to solve the problem, it is an object of the invention to provide an electronic program guide displaying method for easily searching a large number of channels and programs by the channels, and for searching a searched channel within a short time after the searched channel is once searched.

In order to accomplish the object, the present invention provides: a method for displaying an electronic program guide on a screen of a digital television by using a predetermined graphic processing block when the electronic program guide information is received at a preset time interval through a receiving section of the digital television and stored in a predetermined memory block in the digital television, and the stored electronic program guide information is used for a user to tune a specific channel, and/or search a plurality of information of the programs by a timeline and/or channels, the method including the steps of i) displaying a main menu having at least one subtitle as an aggregate of channels which are classified by predetermined categories on the screen of the digital television, ii) displaying the channels belong to the subtitle at left-sided area of the screen by being listed in vertical direction when the subtitle is selected by using a channel selecting means, and iii) when one of the channels is selected, listing time and titles of the programs of the channel within a box shaped layout at the vertical direction by time order simultaneously displaying marks for manipulating a up and down arrows and a right and left arrows of the channel selecting means as four directional keys at a side of the layout.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a schematic diagram showing an internal construction of a digital television;

FIG. 2a is a view showing components of a main menu of an electronic program guide according to the present invention;

FIG. 2b is a view showing an example of a channel selection means according to the present invention;

FIG. 3 is a view showing the main menu according to the present invention;

FIG. 4 is a view an initial electronic program guide of an ALL of a channel guide according to the present invention;

FIG. 5 is a view showing an initial electronic program guide of a charged channel according to the present invention;

FIG. 6 is a view showing an electronic program guide of a VIEW BY TIMELINE of a charged channel according to the present invention;

FIG. 7 is a view showing specific information of a program a charged channel according to the present invention;

FIG. 8 is a view showing a settlement window of a charged channel according to the present invention; and

FIG. 9 is a schematic view showing a conventional electronic program guide displaying method.

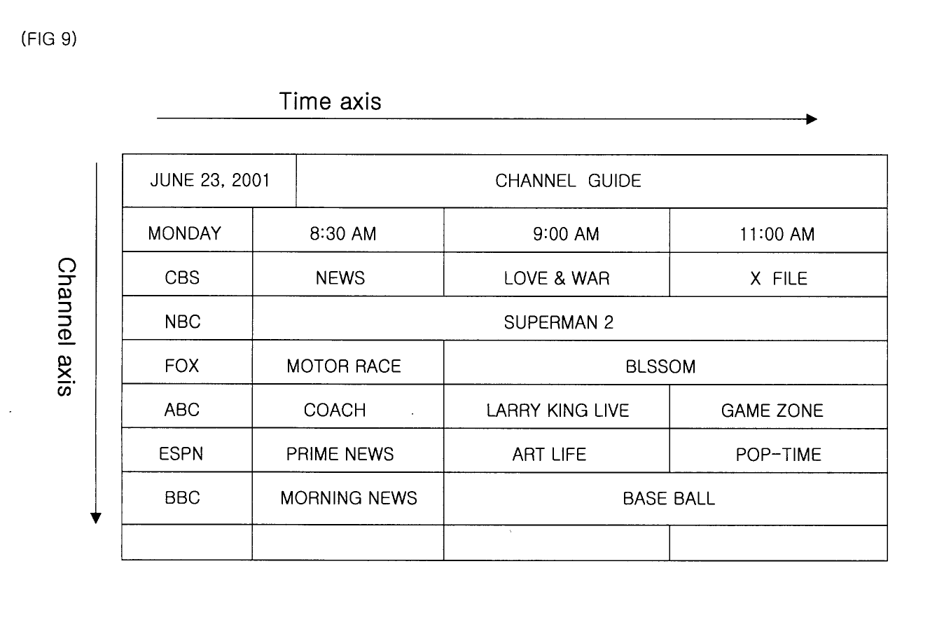

### DETAILED DESCRIPTION OF THE PREFERRED EMBODIMENT

The preferred embodiment of the present invention will be detailed described with accompanying drawings.

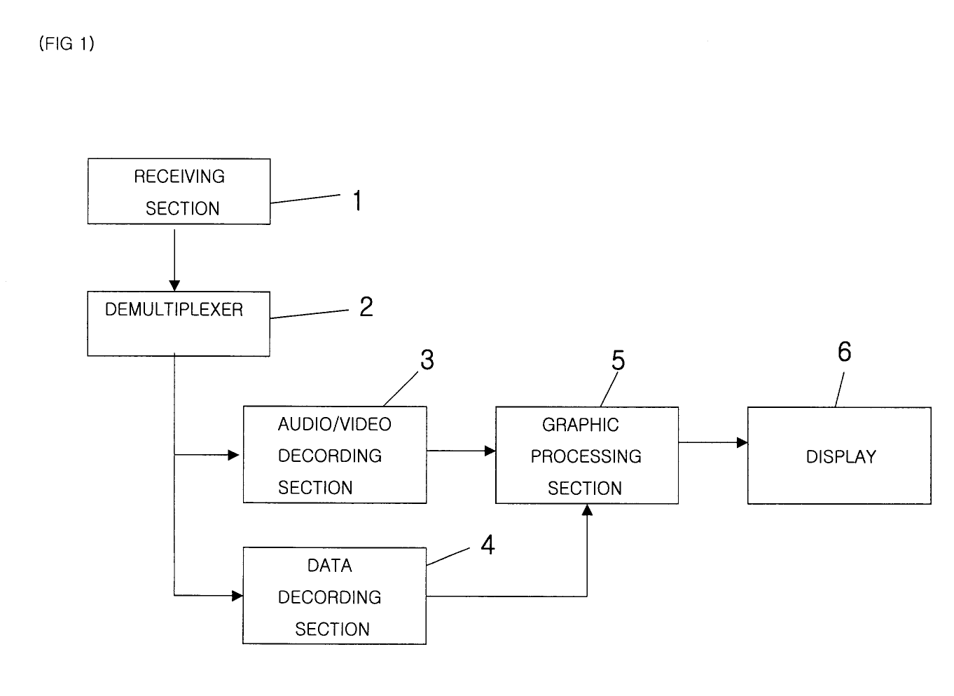

FIG. 1 is a schematic diagram showing an internal construction of a digital television. Bit-stream data, which are received to a digital television through an antenna, are received through a predetermined receiving section 1, a broadcasting signal, which is selected from the received broadcasting signal of a channel by a user, is extracted by a demultiplexer 2, and a moving and audio signals among the extracted broadcasting signals are decoded in the MPEG by an audio and video decoding section 3, so that the decoded signal is displayed on a display 6 such as a screen of a television or a liquid crystal display through a predetermined graphic processing section 5.

Meanwhile, information related to the broadcasting program among the data received to the television, for example, contents data related to detailed information with respect to a character and a district associated to the program, an advertisement of a home-shopping, and a viewers rating, are simultaneously received thereto. By which data of the electronic program guide, having information related to the contented of program and broadcasting time schedule of the broadcasting channel of the digital television among the contents of the contents data, are also received simultaneously, the viewer can read information of channels ranged from tens to hundreds all together.

The electronic program guide data are displayed on the display 6 such as the screen of the television and the liquid crystal display by the graphic processing section 5 through decoding by the data decoding section 4 which process the contents data passing through the demultiplexer 2 after the electronic program guide is received through the receiving section 1 in accordance with a processing procedures of the audio and video information in the packet type bit-stream, so that the electronic program guide are displayed on the screen of the television by being synchronized with the audio and video data decoded by the audio and video decoding section 3.

Meanwhile, the audio and video decoding section 3, the data decoding section 4, and the graphic processing section 5 are controlled by commands from a predetermined controlling section (not shown) being installed with a microprocessor therein. The audio and video data and the contents data received through the receiving section 1 are stored in a memory section (not shown) using a memory component such as a RAM (random access memory) so that the data are decoded and displayed on the display 6 according to the signal from the controlling section.

Hereinafter, an electronic program guide displaying method for displaying the electronic program guide among the data processed by the signal processing procedure will be described in more detailed way.

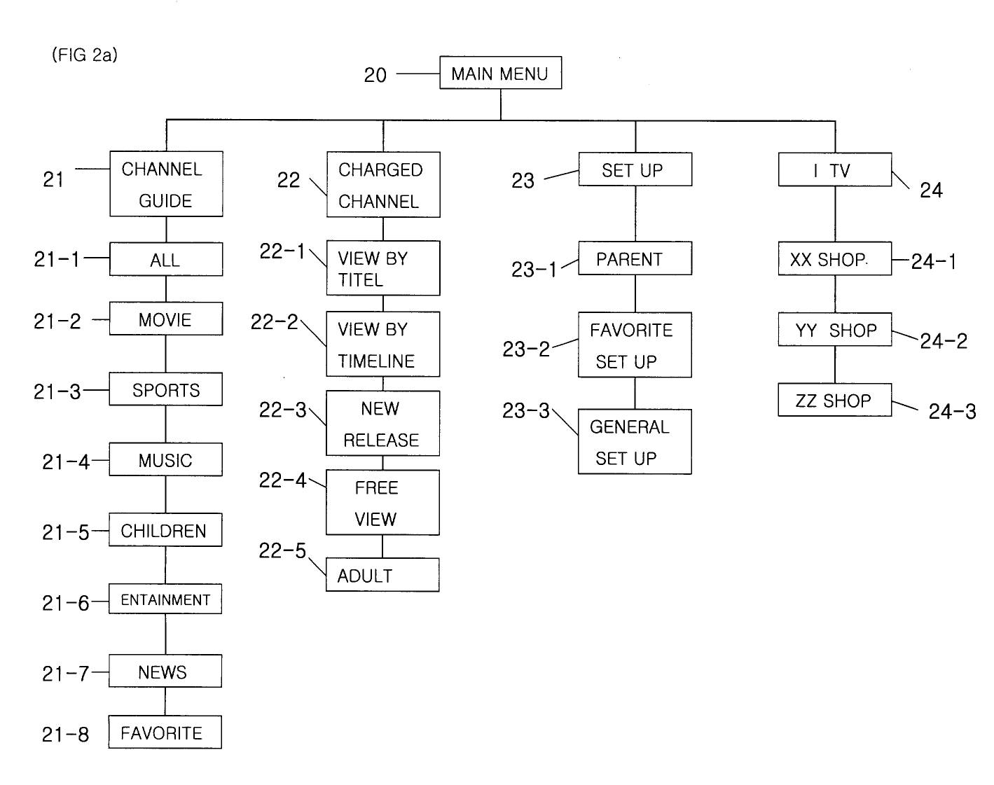

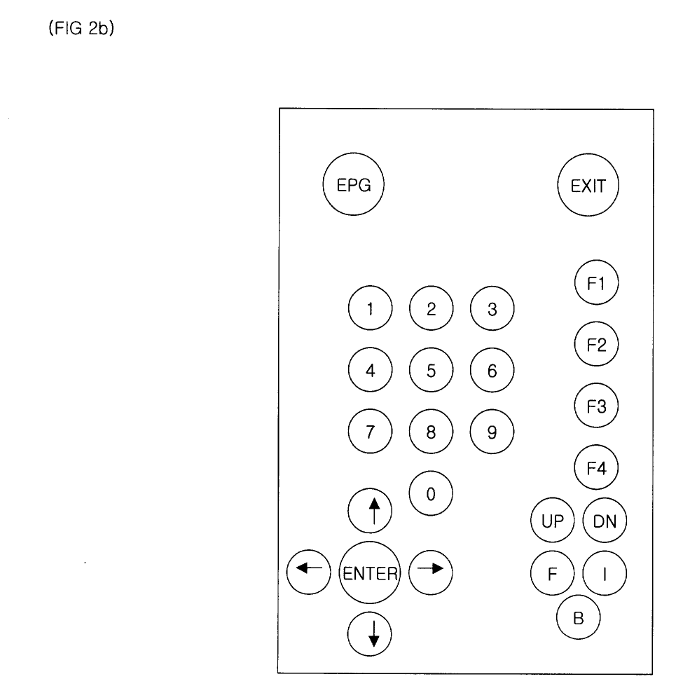

FIG. 2a is a view showing components of a main menu of an electronic program guide of the present invention by using a directory structure.

According to the electronic program guide displaying method, the channels received through the antenna are not displayed on the screen of the television in the conventional method having a horizontal axis of the screen of the television as a time axis, and a vertical axis as a channel axis and program axis, instead of, the electronic program guide displaying method of the present invention has a subtitle which channels are classified by respective categories with a predetermined classifying standard according to the characteristics of the respective channels. According to the preferred embodiment of the present invention, a main menu 20 includes a channel guide 21 in which channels and programs can be searched by classification, a charged channel 22 collected with charged channels which a user can watch after paying fee, a SET UP 23 for setting functions related to the digital television, and an i TV 24 for providing a bi-directional information service such as the Internet.

The channel guide 21 includes categories such as an ALL 21-1 for displaying all broadcasting channels being received and searched, a MOVIE 21-2 for searching movie-related channels, a SPORTS 21-3 for searching sport-related channels, a MUSIC 21-4 for searching music-related channels, a CHILDREN 21-5 for searching children-related channels, an ENTERTAINMENT 21-6 for searching entertainment-related channels, a NEWS 21-7 for searching news-related channels, and a FAVORITE 21-8 for searching a user's own favorite channels. The user can search a certain channel corresponding a selected category by selecting his/her desired category from the channel guide.

Moreover, the charged channel 22 includes a VIEW BY TITLE 22-1 for listing and displaying the channels by titles or names, a VIEW BY TIMELINE 22-2 for listing and displaying the channels by time, a NEW RELEASE 22-3 for listing and displaying the channels by an updating order, a FREE VIEW 22-4 for listing and displaying the free service, and an ADULT 22-5 for adult only.

The SET UP 23 includes a PARENTS 23-1 for allowing only a parent viewer to manipulate the channel guide, a FAVORITE SETUP 23-2 for allowing a viewer to manipulate his/her own standard regarding his/her favorite channels and a channel arranging method, and a GENERAL SETUP 23-3 for manipulating general item of the channel guide.

The iTV 24 includes channels which data can be transmitted and received in bi-direction by the Internet or wire/wireless communication terminal, in drawing, only channels capable of communicating in the bi-direction for the data are illustrated.

Meanwhile, a channel selecting means used in the digital television is a conventional remote controller. The digital television is constructed to detect a key input from the user by means of the channel selecting means and an infrared transmission/receiving. According to the preferred embodiment of the present invention, the channel selecting means includes a variety of input keys as shown in FIG. 2b. Described in more detail, the channel selecting means an EPG start key for commanding performance of an electronic program guide being watched, an ENTER key for commanding an agreement of contents data (mainly used to determine whether watching a charged channel or not) required with a selection or instruction from the user during watching ed described, an EXIT key for completing the display of the EPG, numeral keys of 0 (zero) to 9 (nine) for inputting number of the channel, a FUCTION key of F1 to F4 for easy movement between the subtitles 21, 22, 23, and 24, and short keys for rapidly performing the movement between the main menu 20 and the subtitles 21, 22, 23, and 24, and the channels, and watching information related the channels and programs are provided. Here, the short keys include PAGE UP and PAGE DOWN keys for viewing a screen for displaying the channels by a page, an INFORMATION key for reading information when information data related to a program broadcasted in the selected channel exist, a FAVORITE key for immediately reading the user's favorite channels, and a BACK key for viewing a EPG displayed very before the present-displayed EPG. The short keys have respective peculiar colors so that the user can easily distinguish the short keys during manipulation of the remote controller.

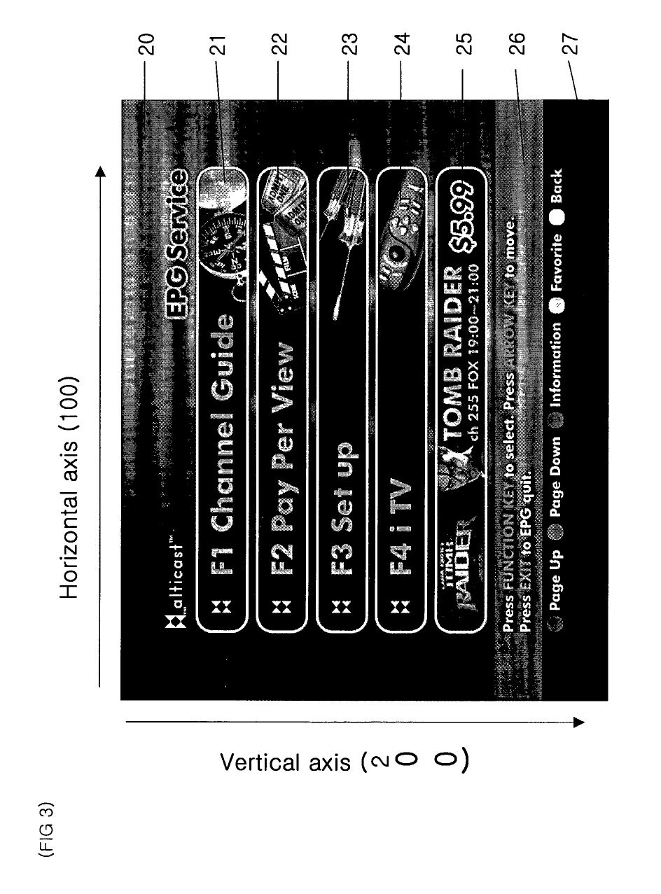

According to the preferred embodiment, the components of the main menu 20 are displayed on the screen of the digital television as the EPG. FIG. 3 is a view for showing the main menu of the present invention, and the main menu will be detailed described hereinafter.

First, for easy description of the screen of the digital television on which the EPG is displayed, let's set a left uppermost end of the screen as a reference point, right direction from the reference point as a horizontal direction 100, and a downward direction from the reference point as a vertical direction 200.

When the EPG is operated by means of the channel selecting means such as the remote controller by the watcher of the digital television, the EPG of the present invention, as shown in FIG. 3, is displayed on the screen of the digital television. As described above, the subtitles 21, 22, 23, and 24 of the main menu 20 are displayed on the screen in the vertical direction 200, and a banner title 25 in which a predetermined advertisement is inserted is displayed at lower side of the subtitles 21, 22, 23, and 24. Moreover, a description 26 in which phrase for describing the key input of the channel selecting means is inserted is displayed at lower side of the banner title 25, and a short key displaying section 27 is displayed at lower side of the description 26. The short key displaying section 27 displays icons of the short keys for rapidly performing the movement between the main menu 20 and the subtitles 21, 22, 23, and 24, and between the channels, and for viewing information related to the programs broadcasted in the channels. Here, the icons of the short keys have respective names and colors identical with the name and colors of the short keys of the channel selecting means as described above, so that the user can immediately select his/her desired channel to watch from the EPG main menu 20.

Meanwhile, in the subtitles 21, 22, 23, and 24, key inputs of F1 through F4 keys indicating the FUNCTION keys of the channel selecting means are displayed so that the user can select the subtitles 21, 22, 23, and 24 by means of the key inputs of the F1 through F4 of the channel selecting means.

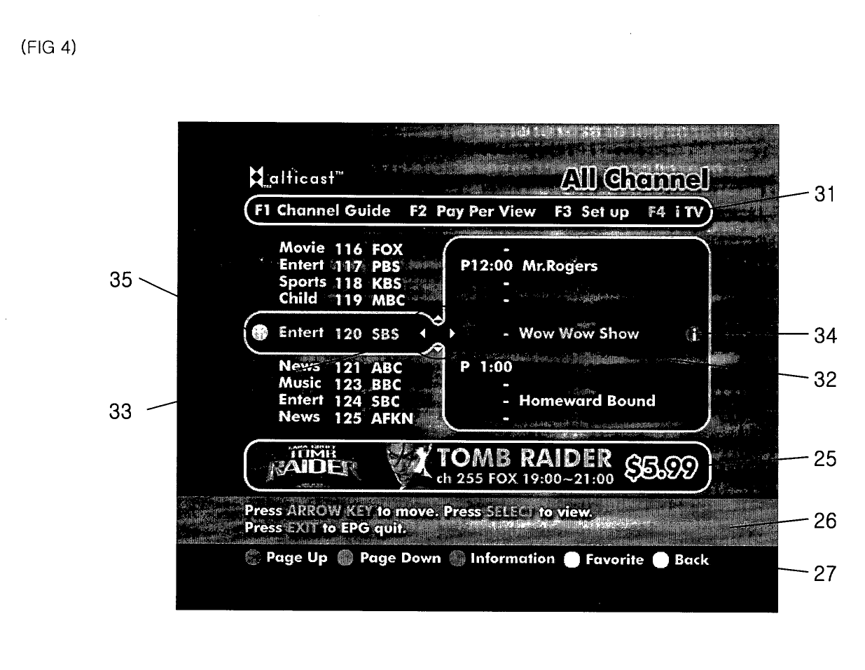

FIG. 4 shows an EPG which is displayed on the screen when the user selects a channel guide 21 from the subtitles 21, 22, 23, and 24 and selects the ALL 21-1 for reading all channels being received through the digital television among the channel guides.

On the uppermost side of the EPG for displaying the ALL 21-1, a subtitle guide section 31 for selecting the subtitles 21, 22, 23, and 24 displayed on the upper main menu 20 in the horizontal direction 100, and channels, which belong to the banner ALL 21-1, like the main menu 20, are listed at a left side and in the vertical direction 200 of the screen. When one channel is selected at this state, the time schedules and titles of the programs belong to the selected channel are displayed at a right side and in the vertical direction 200 in a box shaped layout 32 in order of time. At that time, four directional arrows 33 as indicators for manipulating the up and down arrow keys and left and right arrow keys are displayed a side of the layout.

The user can repeatedly move from the left sided channel area to the right side program area by means of the right and left arrow keys of the four directional arrows 33. When the user has moved to the left sided channel area, he/she can search other channels by means of the up and down arrow keys. Moreover, at the right-sided program area, the user can search programs listed by the timeline by means of the up and down arrow keys. The channel selected by the user is colored with a specific color so that other non-selected channels are visually distinguished.

When there is specific information with respect to a program of the selected channel, a specific information indicating icon 34 for indicating that there are the information is automatically displayed. The specific information with respect to a corresponding program is displayed when an INFORMATION key of the channel selecting means is pressed.

Information of the user's favorite channels is stored in a memory block of the digital television. The user marks a sign of a pre-stored channel before the name of the pre-stored channel with a channel storing indication icon 35. Therefore, the user can easily distinguish the pre-stored channels and other channels through the channel storing indicating icon 35, and recognizes a program having the specific information and other programs without the specific information through the specific information indicating icon 34.

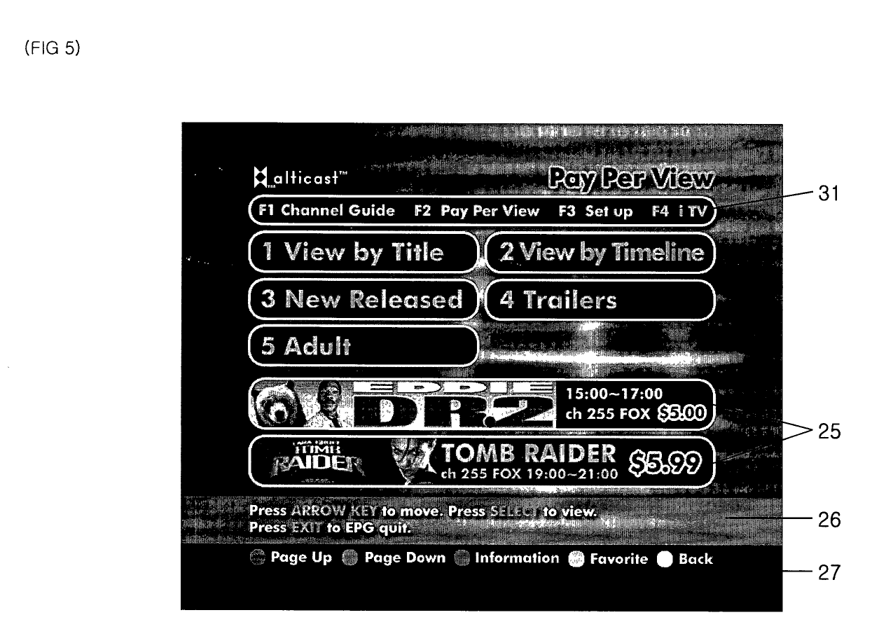

FIGS. 5 through 8 show EPGs displayed on the screen of the user's television when the charged channel 22 is selected from the subtitles of the main menu 20.

The channels belong to the charged channel or programs belong to the channel shoul be broadcasted only when the user pay a predetermined fee, so that a display solution for settlement should be provided. Thus, the EPG displaying method of the charged channels according to the present invention is now described as follows.

FIG. 5 shows an initial view of the charged channel 22. As shown in the drawing, the subtitles of the charged channel is displayed at lower side of the subtitle guide section 31 as shown in FIG. 4, and the banner title 25, the description 26, and the short icon indicating section 27 are sequentially displayed at lower side of the subtitles of the charged channel, so that the movement to other subtitle can be easily performed.

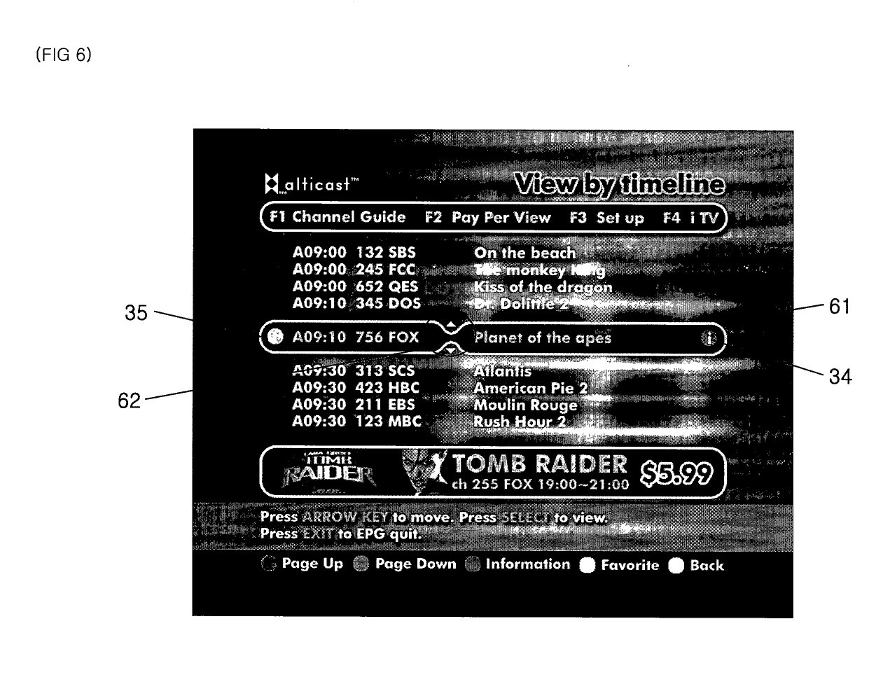

FIG. 6 is a view showing an EPG indicating the VIEW BY TIMELINE in which programs among the subtitles of a charged channel 22 are listed by timeline.

A left side of the EPG indicating the VIEW BY TIMELINE containing time and channels is displayed in the vertical direction 200 by time order, and at a right side of the EPG, titles of programs corresponding to the channels are listed. The selected channel is positioned with the layout 61 and colored in a specific color so that the selected channel can be easily distinguished from the non-selected channel.

At a side of the layout 61, the up and down arrows 62 are displayed as instruction indicators which the user manipulates the up and down arrows displayed intermediate of the layout 61. The user can move the channel by the up and down arrow 62. The program and channel selected by the user are always positioned at a central area.

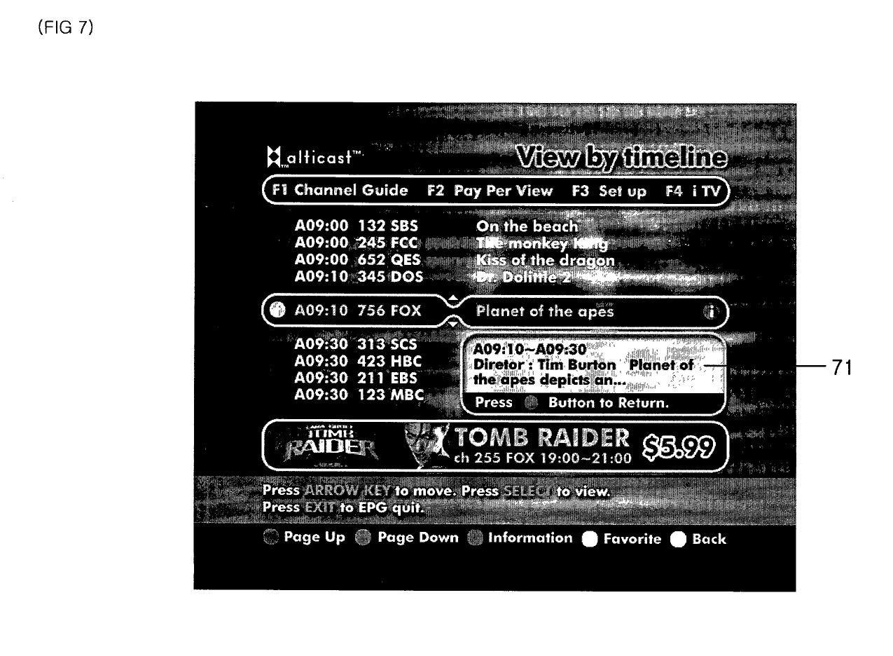

Moreover, the user views the specific information of a program by pressing the INFORMATION key of the channel selecting means restricted to the programs displayed with the specific information indicating icon 34, as shown in FIG. 7, and identifies whether the channel is stored or not through the channel storing indicating icon 35 so that the time required to search the favorite charged channel of the user can be reduced.

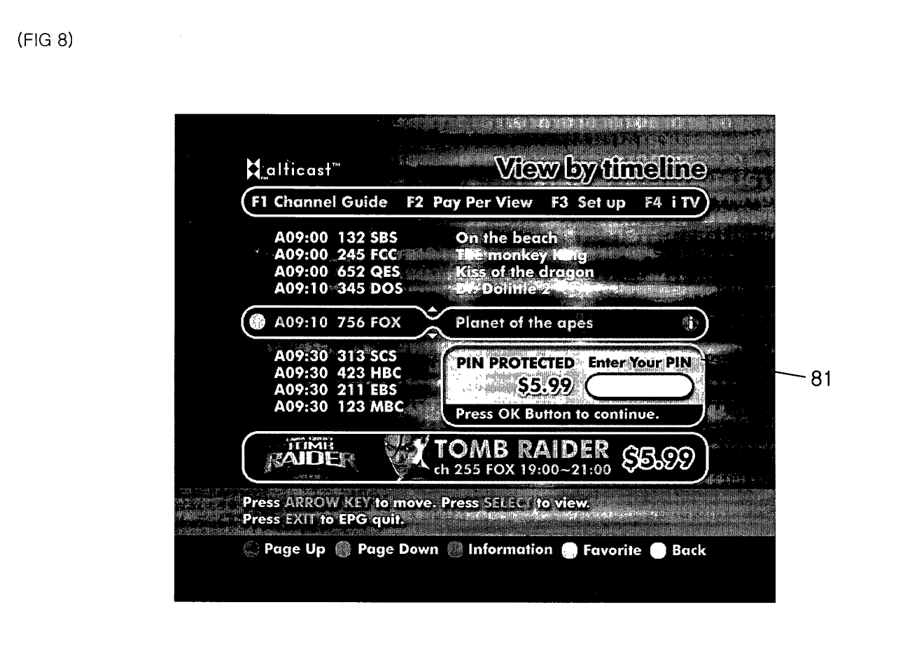

Moreover, the user may know the price of the charged channel with respect to the corresponding program through the specific information indicating icon 34. When the specific information of the program is information for watching fee, as shown in FIG. 8, a settlement window 81, in which the price and a password are inputted, is displayed so that the user can watch the program by inputting the price and password.

The method for displaying an electronic program guide on a screen of a digital television according to the present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

According to the present invention, a user can search more channels and programs simultaneously, and check information related to a specific channel and program at all times. Moreover, in contrary to the conventional electronic program guide for displaying channels in a vertical direction of a television screen and programs in a horizontal direction, according to the present invention, the user can identify a precise starting time and ending time of a program of the specific channel. More programs with respect to the specific channel can be displayed.

Moreover, since the contents of the advertisement can be displayed on the screen without a separated manipulation, the exposing time and concentration of the advertisement are enhanced.

What is claimed is:

1. A method for displaying an electronic program guide on a screen of a digital television by using a predetermined graphic processing block when the electronic program guide information is received at a preset time interval through a receiving section of the digital television and stored in a predetermined memory block in the digital television, and the stored electronic program guide information is used for a user to tune a specific channel, and/or search a plurality of information of the programs by a timeline and/or channels, the method comprising the steps of:
i) displaying a main menu having at least one subtitle as an aggregate of channels which are classified by predetermined categories on the screen of the digital television;
ii) displaying the channels belong to the subtitle at left-sided area of the screen by being listed in vertical direction when the subtitle is selected by using a channel selecting means; and
iii) when one of the channels is selected, listing time and titles of the programs of the channel within a box shaped layout at the vertical direction by time order simultaneously displaying marks for manipulating a up and down arrows and a right and left arrows of the channel selecting means as four directional keys at a side of the layout.

2. The method as claimed in claim 1, further comprising the steps of:
a) searching programs by moving to a program area arranged right side of the screen by means of the right arrow key among the four direction keys; and
b) searching a program corresponding the channel listed by timeline by using the up and down arrow keys.

3. The method as claimed in claim 1, further comprising c) searching a channel area arranged at a left-sided portion of the screen by using the up and down arrow keys among the four directional keys.

4. The method as claimed in claim 1, wherein the selected channel is colored in a specific color.

5. The method as claimed in claim 1, wherein the subtitles belong to the main menus are displayed on the screen in the vertical direction, a banner title in which a predetermined advertisement is inserted is displayed at a lower side of the subtitles, a description on which a phrase for describing key input of the channel selecting means is written is displayed at a lower side of the banner title, and a short icon indicating section for performing movement between the main menu and the subtitles and the channels and displaying short icons to view information related to the program broadcasted by the channel.

6. The method as claimed in claim 5, wherein the short icons have identical colors and names same as the short keys of the channel selecting means.

7. The method as claimed in any one of claims 1 though 6, wherein when a specific information with respect to a corresponding program of the selected channel is existed, a specific information identifying icon is automatically displayed and the specific information of the corresponding program is displayed through a predetermined key input of the channel selecting means.

8. The method as claimed in claim 7, wherein when a charged channel is selected, a specific information identifying icon for settlement for the corresponding program of the selected channel is automatically displayed, and a settlement window in which a fee and a password are inputted is displayed so that the program is settled by inputting the fee and the password.

9. The method as claimed in any one of claim 1 through 6, wherein when a channel registered by a user by using the channel information stored in the predetermined memory block, a channel storing indicating icon is automatically displayed.
